(19) United States
(12) Patent Application Publication
(10) Pub. No.: US 2025/0007283 A1
(43) Pub. Date: Jan. 2, 2025

(54) SYSTEMS AND METHODS FOR ELECTRICAL INVERTER AND SMART LOAD CONTROL INTEGRATION

(71) Applicant: FORTRESS POWER, Langhorne, PA (US)

(72) Inventors: Jinze Wang, Newtown, PA (US); William Gathright, Yardley, PA (US)

(21) Appl. No.: 18/708,860

(22) PCT Filed: Nov. 10, 2022
(86) PCT No.: PCT/US22/49612

§ 371 Date: May 9, 2024

Related U.S. Application Data
(60) Provisional application No. 63/277,686, filed on Nov. 10, 2021.

(51) Int. Cl. H02J 3/00; H02J 3/32; H02J 3/38; H02J 13/00

(52) U.S. Cl. CPC H02J 3/0075; H02J 3/32; H02J 3/38; H02J 13/00001; H02J 13/00006; H02J 2300/24; H02J 2300/28; H02J 2310/12

(57) ABSTRACT

A power management method include receiving, at a user interface, at least one input, generating at least one configuration characteristic based on the at least one input, and configuring a control circuit using the at least one configuration characteristic. The control circuit is associated with an inverter. The method also includes, in response to a determination that electrical power from a first electrical power input at an electrical panel is less than a threshold, using the control circuit, selectively controlling a state of at least one circuit of the electrical panel, and selectively directing power, received from a power storage mechanism and converted by the inverter, to the electrical panel, wherein the power storage mechanism receives electrical power from a second electrical power input.

### CROSS-REFERENCES TO RELATED APPLICATIONS

This PCT International Patent application claims the benefit and priority to U.S. Provisional Patent Application Ser. No. 63/277,686, filed Nov. 10, 2021, the entire disclosure of which is incorporated herein by reference.

### TECHNICAL FIELD

The present disclosure relates to the integration of a power conditioning system (PCS) and smart load control into a single system.

### BACKGROUND

Many homes have electric power generation capabilities to replace or supplement power provided by a utility company. Such power generation capabilities may include a generator or generator system comprising one or more of solar photovoltaic systems, battery energy storage systems, and generator set (“genset”) systems that accept liquid or gaseous hydrocarbon-based fuels. These systems offer many benefits to occupants of a home, such as lower electric bills and access to back-up power when grid power (e.g., power for an interconnected network of electrical connections configured to provide electric power from one or more power generating entities to a power consuming entity) is unavailable.

### SUMMARY

These and other aspects of the present disclosure are disclosed in the following detailed description of the embodiments, the appended claims, and the accompanying figures.

An aspect of the disclosed embodiments includes a power management system. The power management system includes: an electrical panel including a plurality of circuits, each circuit being associated with an electrical load; a first electrical power input electrically connected to the electrical panel, wherein the electrical panel is configured to direct electrical power from the first electrical power input to one or more of the circuits; a power backup interface configured to receive power from a second electrical power input; a power storage mechanism configured to receive power from the power backup interface and to store power in one or more power storage cells; an inverter electrically connected to the power storage mechanism and the electrical panel; a control circuit configured to selectively control a state of each circuit of the electrical panel based on at least one configuration characteristic; and a computing device configured to: receive at least one input; generate at least one configuration characteristic based on the at least one input; and configure the control circuit using the at least one configuration characteristic.

Another aspect of the disclosed embodiments includes a power management apparatus. The apparatus includes: a control circuit associated with an inverter, the control circuit being electrically connected to an electrical panel; a first electrical power input electrically connected to the electrical panel, wherein the electrical panel is configured to direct electrical power from the first electrical power input to one or more circuits of the electrical panel; a power backup interface configured to receive power from a second electrical power input; and a power storage mechanism configured to receive power from the power backup interface and to store power in one or more power storage cells, wherein, in response to a determination that the electrical power from the first electrical power input at the electrical panel is less than a threshold, the control circuit, having been configured using at least one configuration characteristic, selectively controls a state of at least one circuit of the one or more circuits of the electrical panel and selectively directs power, received from the power storage mechanism and converted by the inverter, to the electrical panel.

Another aspect of the disclosed embodiments includes a power management method. The method includes receiving, at a user interface, at least one input, generating at least one configuration characteristic based on the at least one input, and configuring a control circuit using the at least one configuration characteristic. The control circuit is associated with an inverter. The method also includes, in response to a determination that electrical power from a first electrical power input at an electrical panel is less than a threshold, using the control circuit, selectively controlling a state of at least one circuit of the electrical panel, and selectively directing power, received from a power storage mechanism and converted by the inverter, to the electrical panel, wherein the power storage mechanism receives electrical power from a second electrical power input.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A generally illustrates a power management system according to the principles of the present disclosure.

FIG. 1B generally illustrates an alternative power management system according to the principles of the present disclosure.

FIG. 2 generally illustrates an inverter, including a smart load control, of the power management system of FIG. 1A and/or the alternative power management system of FIG. 1B.

FIG. 3 generally illustrates an alternative power management system according to the principles of the present disclosure.

FIG. 4 generally illustrates a panel and interface according to the principles of the present disclosure.

FIG. 5 generally illustrates a smart load control according to the principles of the present disclosure.

FIG. 6 generally illustrates a computing device according to the principles of the present disclosure.

FIG. 7 is a flow diagram generally illustrating a power management method according to the principles of the present disclosure.

FIG. 8 is a flow diagram generally illustrating an alternative power management method according to the principles of the present disclosure.

FIG. 9 is a flow diagram generally illustrating an alternative power management method according to the principles of the present disclosure.

### DESCRIPTION OF THE PREFERRED EMBODIMENTS

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As used herein: a current transformer (CT) includes a sensor that can read the amount of electric current flowing through a wire; a relay control microcontroller unit (RCMUC) includes a microcontroller responsible for controlling relays and contactor; and controllable circuit includes is the combination of a CT to read the current in a wire, and a controllable contactor or relay to make or break the electrical connection of that wire. Additionally, or alternatively, as used herein with respect to power flow: an inflow (e.g., which are described herein with positive numbers) includes current that can potentially flow into a component of the systems and methods described herein from at least one an electrical grid, a photovoltaic (PV) (e.g., which may include alternating current (AC) power from a retrofit PV with inverter already installed, a power storage mechanism (e.g., when associated batteries are discharging), and/or a generator; and an outflow (e.g., which are described herein with negative numbers) includes current that can potentially flow out of a component of the systems and methods described herein from the power storage mechanism (e.g., when batteries are charging), a main service panel, the electrical grid (e.g., when non-grid inflows exceed the load from the main service panel).

As described, many homes have electric power generation capabilities to replace or supplement power provided by a utility company. Such power generation capabilities may include a generator or generator system comprising one or more of solar photovoltaic systems, battery energy storage systems, and genset systems that accept liquid or gaseous hydrocarbon-based fuels. These systems offer many benefits to occupants of home, such as lower electric bills and access to back-up power when grid power is unavailable.

However, the design, installation, and operation of such equipment is typically expensive and complex. Accordingly, systems and methods, such as the systems and methods described herein, configured to provide integration of a series of components such as, but not limited to, an inverter or power conditioning system (PCS) and a relatively small smart load control, may be desirable. The integration of such components into a single unit may provide efficient management of electricity associated with a building (e.g., a single family home, condominium, apartment building, commercial building, office building, and/or other suitable building or location).

Typically, most buildings use or include an electric panel or sometimes called a consumer unit which acts as a component of an electricity supply system that divides an electrical power feed in subsidiary circuits while providing a protective fuse or circuit breaker for each circuit in a common enclosure.

Recent building and/or home designs include electrical systems that include an electrical panel comprising various circuits and/or other suitable electrical components, such as smart circuits (e.g., that allow for various control of a load attached to each smart circuit) and/or smart circuit converters that convert an electrical circuit in a panel to a smart circuit. Such smart circuits may be used to activate, for example a wide range of home appliances and/or other electrical loads, in a range of complex home energy conditions, including, but not limited to, grid outages, circuit schedules based on homeowner inputs and preferences, and the like. Typically, an electrical panel having one or more smart circuits is controlled by a responsive load management system comprising, at least, a computing device, such as a mobile computing device, desktop computing device, server computing device, and the like, either remotely connected or directly connected to the electrical panel. The responsive load management system may control such electrical panels based on amperage limits, demand limits, a battery charge state and capacity, any other suitable factor or information, or a combination thereof.

Such responsive load management systems may make the transition to back-up power generation more convenient, for example, when power from the grid is disconnected. Further, controlling individual electric loads within the building can be optimize for a number of factors that a user (e.g., such as an occupant of the building, an owner of the building, and/or the like) may value, such as lower utility bills, improved battery storage performance, increasing the amount of renewable power (e.g., generated using solar, wind, and/or other renewable power sources) exported to the grid, and/or any other suitable factors.

However, typical responsive load management systems, while potentially allowing the user to control every circuit in the electrical panel, do not include a means to integrate direct current (DC) loads such as a PCS. This introduces complexity in every step of the process. For example, designing an electrical system in a way that is safe and interoperable is more difficult, time consuming, and expensive when there are many different devices from different suppliers that must be considered. Further, an installation may require running wires and conduits to many different appliances, which may increase the installation time and expense, and may introduce more opportunities for errors. If a stand-alone emergency power panel is required, this further increases the cost of the installation. In addition, the user of such responsive load management systems must learn the purpose and operation of each of the different appliances, including how they interact and the steps that must be taken during an emergency. For example, when switching to back-up power the user may have to know to switch off a main disconnect, a stove, and a heat pump before switching on a generator. Failure to do this operation in precisely the correct order introduces opportunities for errors, which can potentially damage property or harm the user and/or other individuals.

Accordingly, systems and methods, such as the systems and methods described herein, configured to completely and effectively control the demand from an electricity source, while being able to convert AC to DC and to manage other electrical supplies, may be desirable. In some embodiments, the systems and methods described herein may be configured to provide an electricity supply system as an all-in-one whole building solution. The systems and methods described herein may be configured to provide any suitable amount of voltage to the entire building (e.g., such as 120 volts, 240 volts, or other suitable voltage), which may allow for updating new and/or existing systems. The systems and methods described herein may be configured to provide a cost-effective means to supply the entire building.

The systems and methods described herein may be configured to integrate a solar inverter with a smart box as an all-in-one electricity supply for the building. The inverter provides for the smart conversion of any DC source into an AC supply that is controlled through a mobile computing application (e.g., such as a mobile phone application, a tablet application, and/or the like) or other suitable application, to other appliances or independent electrical devices.

In some embodiments, the systems and methods described herein may be configured to use or provide 2 microcontrollers: a smart load control and an RCMCU. The RCMCU may be responsible for controlling the relays and contactors. The smart load control may communicate with the RCMCU over a suitable communication mechanism, such as a controller area network bus (CAN bus).

The systems and methods described herein may be configured to use one or more controllable circuits. The one or more controllable circuits may include the electrical grid (e.g., 200 A or other suitable number of amps), a PV (e.g., 50 A or other suitable number of amps), a power storage mechanism (e.g., which may be referred to as an energy storage system (ESS)) (e.g., 125 A or other suitable number of amps), a generator (e.g., 50 A or other suitable number of amps), an EV charger (e.g., 50 A or other suitable number of amps), one or more 6×2-pole relay control circuits (e.g., which may be referred to herein as controllable circuit loads), and/or any other suitable control circuits.

The systems and methods described herein may be configured to make (e.g., connect/turn on) or break (e.g., disconnect/turn off) one or more of the controllable circuits. For example, the systems and methods described herein may be configured to break one or more of the controllable circuits, for example, in response to an overcurrent protection scenario, to preserve a state of charge (SoC) of the power storage mechanism, in response to the grid providing power to the electrical panel and the generator is in operation (e.g., to disconnect the generator), in response to a demand response to another request from a utility entity (e.g., associated with the electrical grid or other suitable utility entity) or system operator, to curtail excess production by solar generate power or other on-sight generator, to control loads for consumer convenience, any other suitable scenario, or a combination thereof.

In some embodiments, the systems and methods described herein may be configured to provide overcurrent protection. For example, the systems and methods described herein may be configured to use or provide an AC bus having a rating of 200 A or other suitable rating. The systems and methods described herein may be configured to prevent any combination of circuits in the electrical panel from exceeding the rating of the AC bus (e.g., 200 A or other suitable rating), without a corresponding circuit tripping (e.g., switching state from an on state to an off state and disconnected the circuit from the associated load). Additionally, or alternatively, the systems and methods described herein may be configured to prevent a combination of inflows from exceeding the AC bus rating. In response to the combination of inflows (e.g., and/or outflows) exceeding the AC rating, the systems and methods described herein may be configured to disconnect power inputs until the total current (e.g., of the combination of inflows and/or outflows) is less than the AC rating. Because current from inflows equal current from outflows, the systems and methods described herein may be configured to monitor, using one or more CT monitors, the inflows and/or the outflows.

In some embodiments, the systems and methods described herein may be configured to break one or more controllable circuits in response to at least one of (i) the current going into the electrical panel is greater than the AC rating, (ii) a source of the overcurrent load is in the electrical panel but not one of the controllable loads, or (iii) the source of the overcurrent load is a controllable circuit that has been set to a force make (e.g., forced on). Breaking all the other inflows may force all of the current to come from the electrical grid. As such, if current from the electrical grid exceeds the AS rating. The systems and methods described herein may be configured to trip the breaker, which may protect associated electrical components and/or loads.

In some embodiments, the systems and methods described herein may be configured to resume operations, after providing overcurrent protection. For example, the systems and methods described herein may be configured to automatically make (e.g., turn on) a controllable circuit that has been turned off for overcurrent protection. The systems and methods described herein may be configured to review each controllable circuit in the off state and determine whether to turn each controllable circuit on according to a priority order (e.g., starting with the highest number controllable circuit or according to any suitable priority order). For example, the systems and methods described herein may be configured to re-make a controllable circuit in response to (i) a desired state of the controllable circuit being set to make, (ii) a contactor status of the controllable circuit being set to break in response to an overcurrent detection, and (iii) the sum of all current inflows being less than a current resume level.

The systems and methods described herein may be configured to, in response to failing to meet at least one of (i), (ii), and (iii), stop searching controllable circuits. Alternatively, the systems and methods described herein may be configured to, in response to meeting all of (i), (ii), and (iii), make the contractor for the controllable circuit, set a status of the contractor to make; and wait a period (e.g., a predetermined number of seconds or other suitable period) before considering the next controllable circuit.

In some embodiments, the systems and methods described herein may be configured to provide state of charge preservation. For example, the systems and methods described herein may be configured to turn off controllable circuits of loads at predefined levels of the SoC of the battery (e.g., or batteries) of the power storage mechanism. Each controllable circuit may have an associated SoC level under which the systems and methods described herein may be configured to break a respective controllable circuit in response to the electrical grid power being cut off (e.g., or reduced below a threshold) to the electrical panel.

In some embodiments, the systems and methods described herein may be configured to, in response to the power from the electrical grid being cut off (e.g., or reduced below a threshold power) to the electrical panel, set each controllable circuit to a pre-configured state (e.g., the make state or the break state). Additionally, or alternatively, the systems and method described herein may be configured to, in response to power from the electrical grid returning (e.g., or being above the threshold power) set each controllable circuit to a state that each controllable circuit was in before the electrical grid power was cut off (e.g., or reduced below the threshold power), which may include a different state or a same state as the pre-determined state.

In some embodiments, in response to the electrical grid power being cut off (e.g., or reduced below a threshold) to the electrical panel, for each controllable circuit, the systems and methods described herein may be configured to determine whether the battery SoC is less than a SoC break level. In response to the battery SoC being less than the SoC break level, the systems and methods described herein may be configured to break the respective controllable circuit and set the contactor status associated with the controllable circuit to a SoC break status.

The systems and methods described herein may be configured to automatically re-make a controllable circuit broken due to SoC preservation. For example, the systems and methods described herein may be configured to, for each controllable circuit with a contactor having an SoC break status determine whether the desired state of the controllable circuit is set to make, and either (i) the electrical grid input at the electrical panel is greater than a threshold (e.g., is providing power under normal operating conditions), or (ii) the SoC of the batter is greater than or equal to an SoC resume level. In response to meeting these conditions, the systems and methods described herein may be configured to make a contractor for a respective controllable circuit, set the status of the contractor to make, and meet another logical condition (e.g., wait a predetermined number of seconds or other suitable period, check a condition against rules-based logic, determine a value from a machine learning algorithm, or other suitable condition) before considering the next controllable circuit.

The systems and methods described herein may be configured to provide a forced make function. For example, if the desired state of a controllable circuit is set to forced make, the systems and methods described herein may be configured to set the contactor of the controllable circuit to make, and set the contactor status to make. The systems and methods described herein may be configured to not automatically break any controllable circuit with a forced make desired state, even in the event of overcurrent protection or SoC preservation. Note that, this does not create a safety concern, even with overcurrent protection, as the systems and methods described herein may be configured to, as a last step during overcurrent protection, force all current to come through the electrical grid breaker, which provides a level of hardware protection.

In some embodiments, the systems and methods described herein may be configured to use or provide one or more (e.g., 3 or other suitable number) dry contractors. The dry contractors may be used for generator control. A start signal occurs when a dry contactor closes, and is sent at a certain battery SoC. A stop signal occurs when the dry contactor opens and is sent at a certain (higher) battery SoC.

The systems and methods described herein may be configured to define, for each dry contractor: a SoC make level at which, when the battery SoC drops below this level, the systems and methods described herein make the dry contractor; an SoC break level, at which, when the battery SoC rises above this level, the systems and methods described herein break the dry contactor; operate during modes, which may include a bitfield selecting which operating modes the dry contactor should operate during (e.g., turn a generator on during off-grid mode and the like); and default state (e.g., make or break) indicating the state of the dry contactor when not in one of the selected operate during modes.

In some embodiments, the systems and methods described herein may be configured to set a desired state for a controllable circuit to one of an on state, an off state, or an automatic state. For example, the systems and methods described herein may be configured to provide, via a computing device, at a user interface, a desired state selection. In response to a user changing the selection of a controllable circuit, the systems and methods described herein may be configured to provide, at the user interface, a confirmation box indicating to the user that the user is about to (de) energize a real circuit of the electrical panel.

In some embodiments, the systems and methods described herein may be configured to prioritize controllable circuits for overcurrent protection using a force-ranked priority of loads associated with each respective controllable circuit. For example, the systems and methods described herein may be configured to provide, at the user interface, a draggable list (e.g., a list that allows the user to select and/or move features of the list using an input device) that allows the user to selectively adjust priority of each controllable circuit. The systems and methods described herein may be configured to store an output of the draggable list and use the output as the priority list for prioritizing controllable circuits.

In some embodiments, the systems and methods described herein may be configured to manage one or more circuit groups. For example, a controllable circuit may below to zero or one or more groups. The systems and methods described herein may be configured to turn off a group as a whole. If a group is “ON”, then every circuit with a desired state of “AUTO” is connected (e.g., set to make) and the state of all other circuits is set to “OFF”. For example, a user with controllable circuits for the HVAC, Refrigerator, and Stove may choose to define groups named “Cooking” and “Comfort”. The “Cooking” group may include the controllable circuit for the Stove and the Refrigerator. The “Comfort” group may include the controllable circuits for the HVAC and refrigerator. In this example the controllable circuit “Stove” is part of the “Cooking” group only. The controllable circuit “HVAC” is part of the “Comfort” group only. The controllable circuit “Refrigerator” is part of both the “Cooking” and “Comfort” groups.

If a user, using the user interface, selects the Cooking group, the systems and methods described herein may be configured to turn off the HVAC, while leaving the Stove and Refrigerator on. Similarly, if the user selects to use the Comfort group, the systems and methods described herein may be configured to leave the HVAC and Refrigerator on and turn off the Stove.

In some embodiments, the systems and methods described herein may be configured to provide, for each controllable circuit, on the user interface, an icon and a controllable circuit name. The systems and methods described herein may be configured to provide, at the user interface, an option for adding a controllable circuit to one or all groups and/or an option to not include the controllable circuit in a group. The systems and methods described herein may be configured to provide, at the user interface, a visual depiction of all controllable circuits and to which group each controllable circuit belongs. The systems and methods described herein may be configured to providing automatic load sensing (e.g., to identify a load based on a pattern in which the load uses electricity).

In some embodiments, the systems and methods described herein may be configured to use or provide an electrical panel including a plurality of circuits. Each circuit may be associated with an electrical load, including any suitable electrical load, such as an appliance, and EV charging station, lighting, and the like. The systems and methods described herein may be configured to use or provide a first electrical power input electrically connected to the electrical panel. The first electrical power input may be associated with an electrical grid or other suitable power source. The electrical panel may be configured to direct electrical power from the first electrical power input to one or more of the circuits of the electrical panel.

The systems and methods described herein may be configured to use or provide a power backup interface configured to receive power from a second electrical power input. The second electrical power input may be associated with at least one renewable energy source, such as a solar energy source, a wind energy source, and/or any other suitable renewable energy source.

The systems and methods described herein may be configured to use or provide a power storage mechanism configured to receive power from the power backup interface and to store power in one or more power storage cells. The power storage mechanism may include a battery comprising the one or more power storage cells, a battery bank comprising a plurality of batteries (e.g., where the one or more power storage cells are associated with at least some of the plurality of batteries), any other suitable power storage mechanism, or a combination thereof.

The systems and methods described herein may be configured to use or provide an inverter electrically connected to the power storage mechanism and the electrical panel. The systems and methods described herein may be configured to use or provide a control circuit associated with the inverter. The control circuit may be configured to selectively control a state of each circuit of the electrical panel based on at least one configuration characteristic. The systems and methods described herein may be configured to use or provide a computing device configured to receive at least one input, generate at least one configuration characteristic based on the at least one input, and configure the control circuit using the at least one configuration characteristic.

The systems and methods described herein may be configured to use the control circuit, having been configured using the at least one configuration characteristic, to determine whether the electrical power from the first electrical power input at the electrical panel is less than a threshold. The systems and methods described herein may be configured to, in response to a determination that the electrical power from the first electrical power input at the electrical panel is less than the threshold, use the control circuit, having been configured using the at least one configuration characteristic, to selectively change a state of at least one circuit of the electrical panel from a first state to a second state. The first state may be associated with one of an on state or an off state of the at least one circuit. The second state may be associated with the other of the on state and the off state of the at least one circuit.

The systems and methods described herein may be configured to use the inverter to convert power from the power storage mechanism and to provide the converted power to the electrical panel. The systems and methods described herein may be configured to, in response to a determination that the electrical power from the first electrical power input at the electrical panel is less than the threshold, use the control circuit, having been configured using the at least one configuration characteristic, to receive an instruction, via the computing device, to change a state of at least one circuit of the electrical panel from a first state to a second state. The instruction may correspond to input provided by a user at the computing device. The input may indicate a desire of the user to change the state of the at least one circuit (e.g., from the off state to the on state).

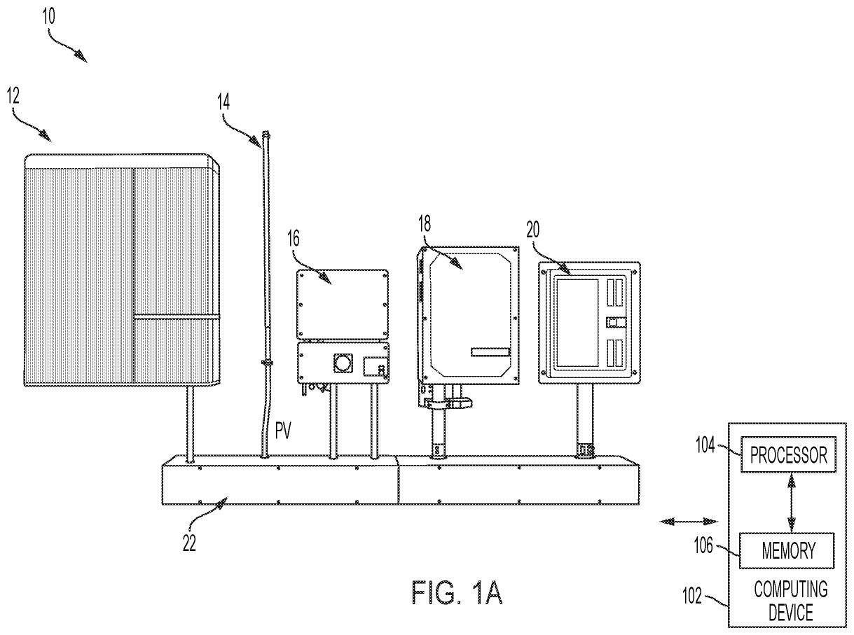

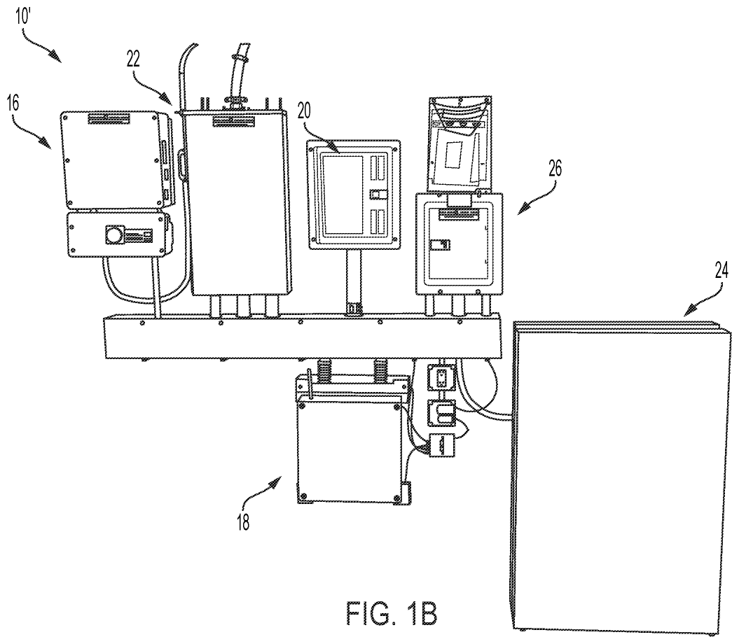

With reference to FIG. 1A, a power management system 10, is generally illustrated. The system 10 may include a battery 12 that includes a smart panel integrated therein. The battery 12 may include any suitable battery comprising any suitable number of battery cells and/or other suitable electrical components, and/or sensors. The smart panel and/or the battery 12 may be in communication with a computing device, such as the computing device 102.

The computing device 102 may include any suitable computing device including a mobile computing device (e.g., a smart phone, tablet, or other suitable mobile computing device), a laptop-computing device, a desktop computing device, or any other suitable computing device. The computing device 102 may include a processor 104 and a memory 106.

The processor 104 may include any suitable processor, such as those described herein. Additionally, or alternatively, the computing device 102 may include any suitable number of processors, in addition to or other than the processor 104. The memory 106 may comprise a single disk or a plurality of disks (e.g., hard drives), and includes a storage management module that manages one or more partitions within the memory 106.

In some embodiments, memory 106 may include flash memory, semiconductor (solid state) memory or the like. The memory 106 may include Random Access Memory (RAM), a Read-Only Memory (ROM), or a combination thereof. The memory 106 may include instructions that, when executed by the processor 104, cause the processor 104 to, at least, perform the functions associated with the systems and methods described herein.

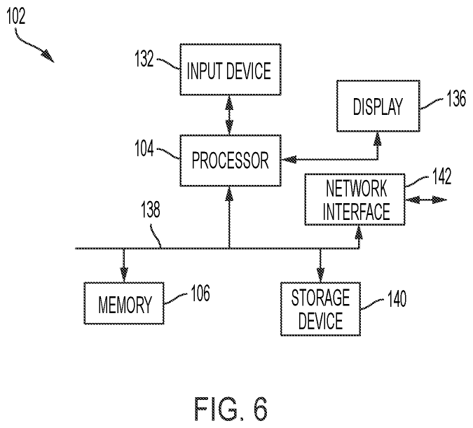

The computing device 102 may include a user input device 132, as is generally illustrated in FIG. 6 that is configured to receive input from a user of the computing device 102 and to communicate signals representing the input received from the user to the processor 104. For example, the user input device 132 may include a button, keypad, dial, touch screen, audio input interface, visual/image capture input interface, input in the form of sensor data, etc.

The computing device 102 may include a display 136 that may be controlled by the processor 104 to display information to the user. A data bus 138 may be configured to facilitate data transfer between, at least, a storage device 140 and the processor 104. The computing device 102 may also include a network interface 142 configured to couple or connect the computing device 102 to various other computing devices or network devices via a network connection, such as a wired or wireless connection, or other suitable connection. In some embodiments, the network interface 142 includes a wireless transceiver.

The storage device 140 may comprise a single disk or a plurality of disks (e.g., hard drives), one or more solid-state drives, one or more hybrid hard drives, and the like. The storage device 140 may include a storage management module that manages one or more partitions within the storage device 140. In some embodiments, storage device 140 may include flash memory, semiconductor (solid state) memory or the like.

In some embodiments, the battery 12, smart panel, and/or an inverter 16 may be configured to manage the electricity or power supplied from one or more power sources. The one or more power sources may include any suitable power source including the electrical grid, one or more solar power sources (e.g., captured using one or more photovoltaic cells), one or more wind power sources (e.g., captured using one or more wind turbines), one or more other renewable power sources, other suitable power sources, or a combination thereof.

The inverter 16 may include any suitable power inverter configured to convert DC power from the battery 12 to AC power, for use in operating various electrical devices associated with circuits of an associated electrical panel, such as the panel 20. The panel 20 may include any suitable electrical panel, including a 100 Ampere (A) circuit backup panel configured to interact with a power backup interface 18, which may connect the panel 20 to the inverter 16.

In some embodiments, the inverter 16 (e.g., which may be referred to as a PV inverter) may be utilized to convert a DC output 14 of a PV solar panel into an AC output which can be fed into the electrical grid described herein or used by a local, off-grid, electrical network, and the like. For example, the inverter 16 may be coupled directly to the electrical grid and AC power generated by the inverter 16 is based on DC power received from a PV solar panel.

AC power may also be drawn from or purchased from the main local grid or from a battery source, such as the battery 12, or other suitable battery or power storage systems, such as those described herein. In some embodiments, the inverter 16 operates based on an AC voltage reference from the electrical grid and if the electrical grid fails, the inverter 16 may also fail. Additionally, or alternatively, PV electric power can be sold to the grid and AC power may be purchased back from the grid though the main panel 20.

FIG. 1B generally illustrates a power management system 10′ that may include, at least some, similar features to those of system 10. For example, the system 10′ may include the inverter 16, and the panel 20. Additionally, or alternatively, the system 10′ may include an energy gateway 22 that provides an automatic transfer switch that acts as a bridge between the electrical grid and renewable, such as solar or other renewable energy, storage systems, such as the battery 12 of the system 10, a power wall 24 of the system 10′, and/or other suitable storage system).

A generation panel 25 may include a solar and battery power connect. In some embodiments, a smart panel may be configured to automatically shut off heavy loads when the grid is disconnected or otherwise not providing energy to the system 10″.

In some embodiments, the user of the system 10′ (e.g., and/or the system 10) may interact with a power management application. The power management application may be disposed on or executed by the computing device 102 or other suitable computing device.

The power management application may include a software application locally disposed on the computing device 102 or remotely located from the computing device 102, such as on a server computing device, accessible, by the user, via the computing device 102 on a network enabled interface, such as a web application, or other suitable interface, and/or disposed partially on the computing device 102 and partially disposed remote from the computing device 102. It should be understood that the user may access the power management application using any suitable technique in combination with or instead of those described herein.

Using the computing device 102 to access an interface associated with the power management application, the user may change a state of one or more circuits of the panel 20. For example, the user may desire a particular load to be on during a power outage, such as a laundry appliance. The user may turn a circuit associated with the load on in order to use the appliance associated with the load. The user may then turn the circuit associated with the load off, when the user is no longer using the appliance, in order to direct energy to other loads associated with circuits of the panel 20.

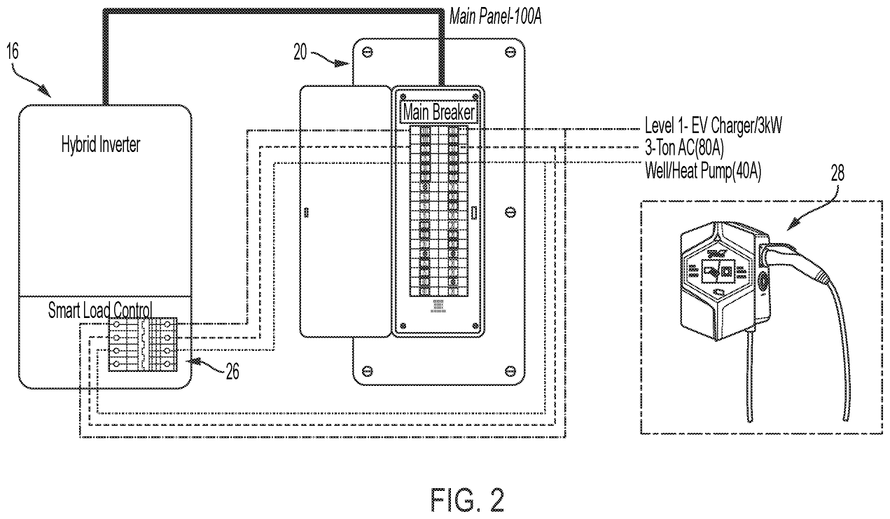

As is generally illustrated in FIG. 2, when combined as a smart control component, the panel 20, shown with 100 A, is integrated with the inverter 16 (e.g., which may include a 12 kilowatt inverter or other suitable inverter) and a smart load control 26. In some embodiments, the panel 20 may include a circuit dedicated to an electric vehicle (EV) charging station 28.

The user may selectively control electricity flow to the EV charging station using the power management application, via the computing device 102. For example, the user may select one or more conditions for providing power to the EV charger (e.g., such as an off peak condition, a weather condition, a time of day condition, and the like). The power management application may interact with the smart load control 26 to select or de-select (e.g., turn on or off) the circuit dedicated to the EV charge, responsive to the one or more conditions being met.

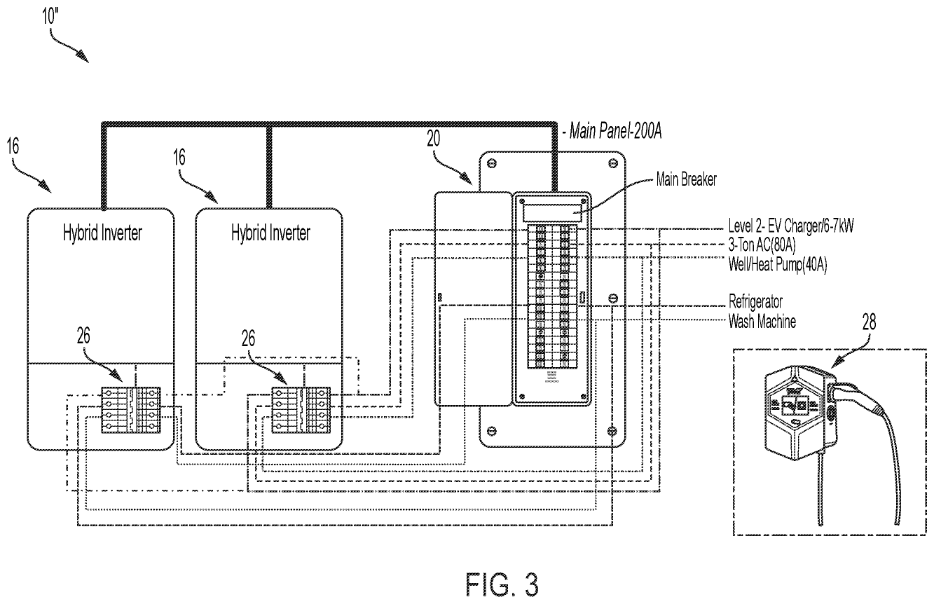

With reference to FIG. 3, a power management system 10″ is generally illustrated. The system 10″ may include features similar to those of the system 10 and/or the system 10′. For example, the system 10″ may include a plurality of inverters 16, each including a respective smart load control 26, and a panel 20. Integration of circuit supplies and conductor connections into the main service panel 20 are be illustrated as double lines denoting dual-pole circuits. In some embodiments the system 10″ may include a smart load control 26 that is in communication with each of the inverters 16 (e.g., such that a single smart load control 26 may control various aspects of the system 10″). Additionally, or alternatively, the system 10″ may include a plurality of smart load controls 26 remotely disposed relative to the inverters 16 (e.g., such that the smart load controls 26 are not integrated into respective inverters 16).

In some embodiments, the smart load control 26 may be configured to proactively manage all connected devices of the system 10, the system 10′, and/or the system 10″ (e.g., or any other suitable system) using software control and/or hardware disconnect control. In some embodiments, the smart load control 26 may include a combiner function configured to use the bus bar of any of the systems described herein to combine power output of any of the inverters 16 described herein with any of the power storage mechanisms described herein.

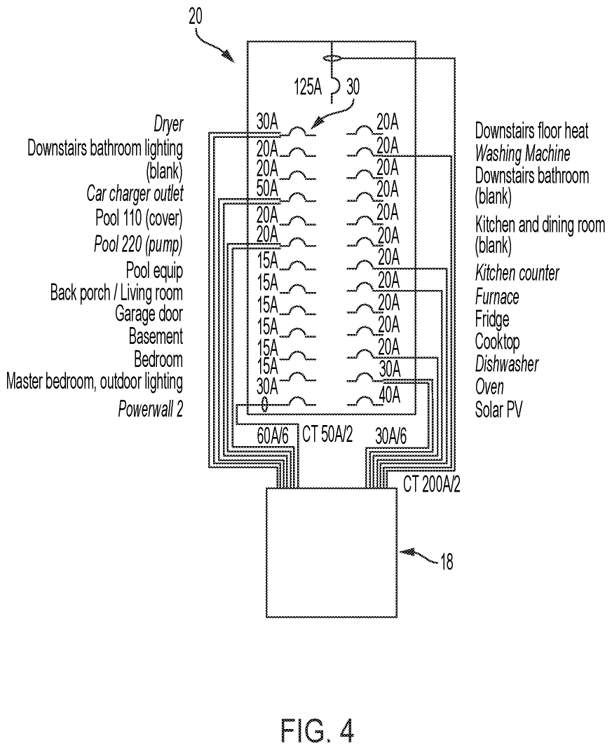

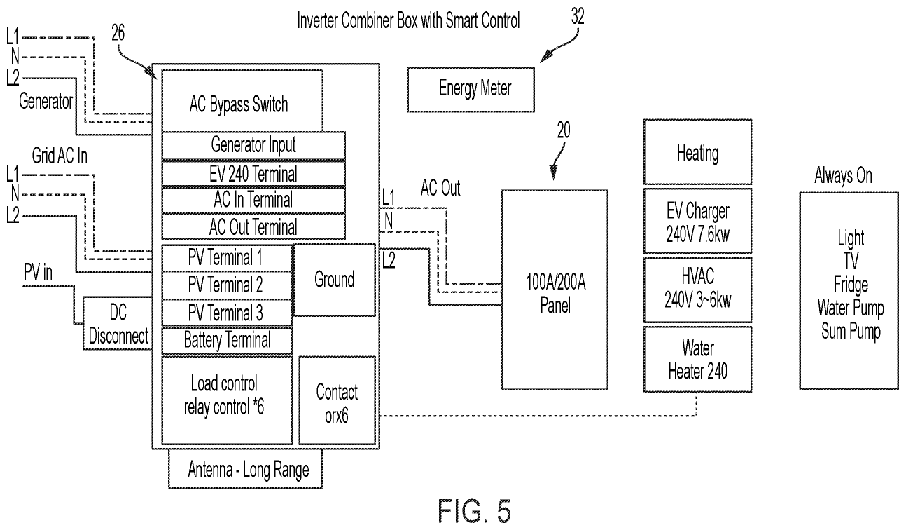

Additionally, or alternatively, as is generally illustrated in FIG. 4, circuit names denote which circuits 30, of the panel 20, are governed through the interface 18. In some embodiments, the smart load control 26 of the inverter 16, as is generally illustrated in FIG. 5, includes a smart input and/or output, which may incorporate an AC bypass switch having the generator, grid AC, and PV inputs.

The generator, AC in and/or out terminals with the EV 240 terminal are shown with an energy meter 32. A DC disconnect may include PV terminals, and a battery terminal with a control board. The smart load control 26 may communicate with or be connected to the panel 20 (e.g., illustrated as a 100 A/200 A panel) for AC out, typically used for heating, EV Charger (20VC 3-6 kw), water heater 240, and/or any other suitable electrical load, appliance, or application.

In some embodiments, the grid AC in includes any suitable wire gage, for example, and without limitation, American Wire Gage (AWG) 2 or 3 copper or aluminum AWG 2 or I/O with a lug size range from 2/0 to AWG 4, or any suitable wire gage and/or characteristic. The AC out to the panel 20 may include an AWG 2 or 3 copper or aluminum AWG 2 or I/O lug size range from 2/0 to AWG 4, or any suitable wire gage and/or characteristic.

The generator AC in may include an AWG 2 or 3 copper or aluminum AWG 2 or I/O lug size range from 2/0 to AWG 4, or any suitable wire gage and/or characteristic. The EV AC terminal may include a wire gage, such as a AWG 8 or 6, or any suitable wire gage and/or characteristic, which is integrated within the smart load control 26 circuit and uses push in, or other suitable, terminals.

In some embodiments, the smart load control 26 may be disposed remote (e.g., not integrated into) from the inverter 16. For example, the smart load control 26 may be disposed in any suitable location and in communication with the inverter 16.

In some embodiments, the electrical panel 20 including a plurality of circuits. Each circuit may be associated with an electrical load, including any suitable electrical load, such as an appliance, and EV charging station, lighting, and the like. A first electrical power input may be electrically connected to the electrical panel 20. The first electrical power input may be associated with an electrical grid or other suitable power source. The electrical panel 20 may be configured to direct electrical power from the first electrical power input to one or more of the circuits of the electrical panel 20.

In some embodiments, the power backup interface 18 may be configured to receive power from a second electrical power input. The second electrical power input may be associated with at least one renewable energy source, such as a solar energy source, a wind energy source, and/or any other suitable renewable energy source.

A power storage may be configured to receive power from the power backup interface 18 and to store power in one or more power storage cells. The power storage mechanism may include a battery, such as the battery 12 or other suitable battery, comprising the in one or more power storage cells, a battery wall, such as the battery wall 24 (e.g., which may be referred to herein as a battery bank or a power storage bank) or other suitable battery wall, comprising a plurality of batteries (e.g., where the one or more power storage cells are associated with at least some of the plurality of batteries), any other suitable power storage mechanism, or a combination thereof.

The inverter 16 may be electrically connected to the power storage mechanism and the electrical panel 20. A control circuit, such as the smart load control 26, may be associated with the inverter 16. In some embodiments, the smart load control 26 may be a separate component from the inverter (e.g., not integrated into the inverter), may be integrated into the inverter, or may be disposed proximate the invertor. The smart load control 26 may be communication (e.g., electrically and/or otherwise connected) with the inverter. The smart load control 26 may be configured to selectively control a state of each circuit of the electrical panel 20 based on at least one configuration characteristic. A computing device, such as the computing device 102, may be configured to receive at least one input, generate at least one configuration characteristic based on the at least one input, and configure the smart load control 26 using the at least one configuration characteristic.

In some embodiments, the smart load control 26, having been configured using the at least one configuration characteristic, may determine whether the electrical power from the first electrical power input at the electrical panel 20 is less than a threshold. In response to a determination that the electrical power from the first electrical power input at the electrical panel 20 is less than the threshold, the smart load control 26, having been configured using the at least one configuration characteristic, may selectively change a state of at least one circuit of the electrical panel 20 from a first state to a second state. The first state may be associated with one of an on state or an off state of the at least one circuit. The second state may be associated with the other of the on state and the off state of the at least one circuit.

The inverter 16 may be configured to convert power from the power storage mechanism and to provide the converted power to the electrical panel 20, in response to the determination that the electrical power from the first electrical power input at the electrical panel 20 is less than the threshold. The smart load control 26 may, in response to a determination that the electrical power from the first electrical power input at the electrical panel 20 is less than the threshold, having been configured using the at least one configuration characteristic, may receive an instruction, via the computing device 102, to change a state of at least one circuit of the electrical panel from a first state to a second state. The instruction may correspond to input provided by a user at the computing device 102. The input may indicate a desire of the user to change the state of the at least one circuit (e.g., from the off state to the on state).

In some embodiments, the system 10, the system 10′, and/or the system 10″ may perform the methods described herein. However, the methods described herein as performed by the system 10, the system 10′, and/or the system 10″ are not meant to be limiting, and any suitable system may perform the methods described herein without departing from the scope of this disclosure.

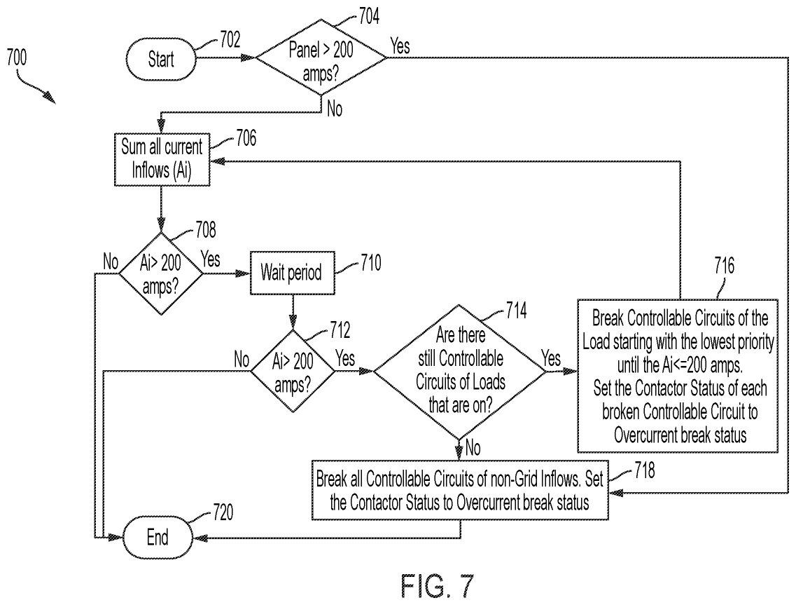

FIG. 7 is a flow diagram generally illustrating a power management method 700 according to the principles of the present disclosure. At 702, the method 700 begins. At 704, the method 700 determines whether the electrical power at the electrical panel 20 is greater than 200 A. If yes, the method 700 continues at 718. If not, the method 700 continues at 706.

At 706, the method 700 sums all current inflows (Aj).

At 708, the method 700 determines whether Aj is greater than 200 A. If yes, the method 700 continues at 710. If not, the method 700 continues at 720.

At 710, the method 700 waits a period.

At 712, the method 700 determines whether Aj is greater than 200 A. If yes, the method 700 continues at 714. If no, the method 700 continues at 720.

At 714, the method 700 determines whether any controllable circuits having associated loads are on. If yes, the method 700 continues at 716. If not, the method 700 continues at 718.

At 716, the method 700 breaks controllable circuits having an associated load starting with the lowers priority until Aj is less than or equal to 200 A. The method 700 sets the contractor status of each broken controllable circuit to an overcurrent break status. The method 700 continues at 706.

At 718, the method 700 breaks all controllable circuits of non-grid inflows. The method 700 sets the contractor status for each broken controllable circuit to the overcurrent break status.

At 720, the method 700 ends.

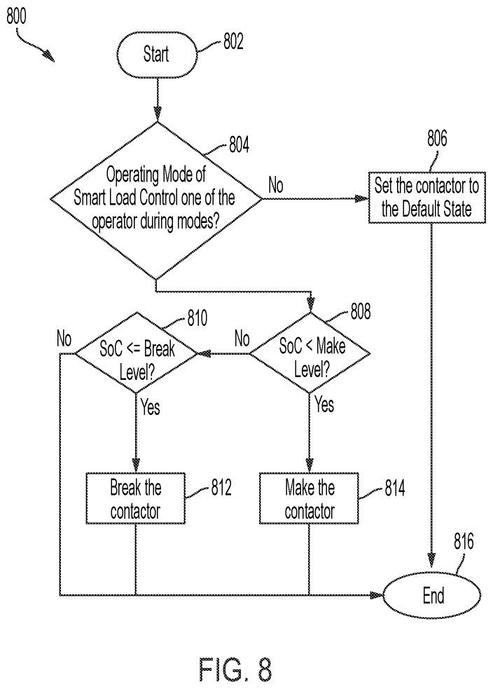

FIG. 8 is a flow diagram generally illustrating a power management method 800 according to the principles of the present disclosure. At 802, the method 800 begins.

At 804, the method 800 determines whether an operating mode of the smart load control is one of the operator during modes. If yes, the method 800 continues at 808. If no, the method 800 continues at 806.

At 806, the method 800 sets a contractor associated with a respective controllable circuit to a default state. The method 800 continues at 816.

At 808, the method 800 determines whether a SoC of a battery is less than a make level. If yes, the method 800 continues at 814. If no, the method continues at 810.

At 810, the method 800 determines whether the SoC is less than or equal to a break level. If yes, the method continues at 812. If no, the method 800 continues at 816.

At 812, the method 800 breaks the contractor associated with the respective controllable circuit.

At 814, the method 800 makes the contractor associated with respective the controllable circuit.

At 816, the method 800 ends.

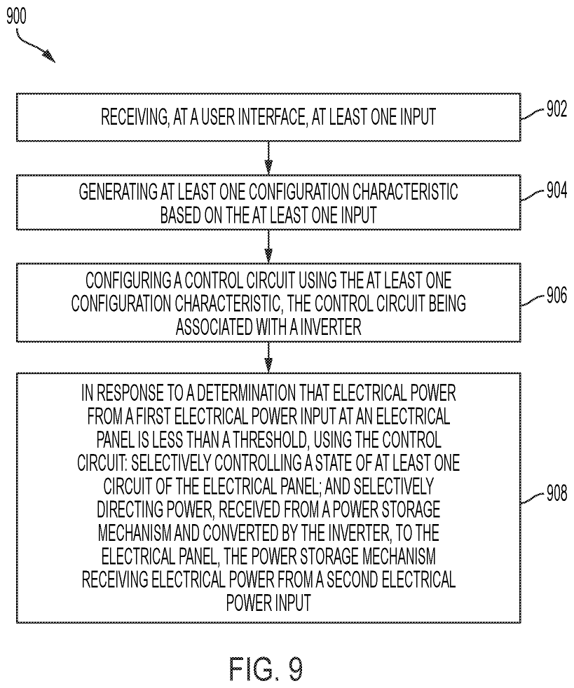

FIG. 9 is a flow diagram generally illustrating an alternative power management method 900 according to the principles of the present disclosure. At 902, the method 900 receives, at a user interface, at least one input.

At 904, the method 900 generates at least one configuration characteristic based on the at least one input.

At 906, the method 900 configures a control circuit using the at least one configuration characteristic. The control circuit may be associated with an inverter.

At 908, the method 900, in response to a determination that electrical power from a first electrical power input at an electrical panel is less than a threshold, uses the control circuit to selectively control a state of at least one circuit of the electrical panel and to selectively direct power, received from a power storage mechanism and converted by the inverter, to the electrical panel. The power storage mechanism may receive electrical power from a second electrical power input.

Clause 1. A power management system comprising: an electrical panel including a plurality of circuits, each circuit being associated with an electrical load; a first electrical power input electrically connected to the electrical panel, wherein the electrical panel is configured to direct electrical power from the first electrical power input to one or more of the circuits; a power backup interface configured to receive power from a second electrical power input; a power storage mechanism configured to receive power from the power backup interface and to store power in one or more power storage cells; an inverter electrically connected to the power storage mechanism and the electrical panel; a control circuit a configured to selectively control a state of each circuit of the electrical panel based on at least one configuration characteristic; and a computing device configured to: receive at least one input; generate at least one configuration characteristic based on the at least one input; and configure the control circuit using the at least one configuration characteristic.

Clause 2. The power management system of claim 1, wherein the first electrical power input is associated with an electrical grid.

Clause 3. The power management system of claim 1, wherein the second electrical power input is associated with at least one renewable energy source.

Clause 4. The power management system of claim 3, wherein the at least one renewable energy source includes at least one of a solar energy source and a wind energy source.

Clause 5. The power management system of claim 1, wherein the power storage mechanism includes a battery comprising the in one or more power storage cells.

Clause 6. The power management system of claim 1, wherein the power storage mechanism includes a battery bank comprising a plurality of batteries, and wherein the one or more power storage cells are associated with at least some of the plurality of batteries.

Clause 7. The power management system of claim 1, wherein the control circuit, having been configured using the at least one configuration characteristic, determines whether the electrical power from the first electrical power input at the electrical panel is less than a threshold.

Clause 8. The power management system of claim 7, wherein, in response to a determination that the electrical power from the first electrical power input at the electrical panel is less than the threshold, the control circuit, having been configured using the at least one configuration characteristic, selectively change a state of at least one circuit of the electrical panel from a first state to a second state.

Clause 9. The power management system of claim 8, wherein the inverter converts power from the power storage mechanism and provides the converted power to the electrical panel.

Clause 10. The power management system of claim 7, wherein, in response to a determination that the electrical power from the first electrical power input at the electrical panel is less than the threshold, the control circuit, having been configured using the at least one configuration characteristic, receives an instruction, via the computing device, to change a state of at least one circuit of the electrical panel from a first state to a second state.

Clause 11. The power management system of claim 10, wherein the instruction corresponds to input provided by a user at the computing device.

Clause 12. A power management apparatus comprising: a control circuit associated with an inverter, the control circuit being electrically connected to an electrical panel; a first electrical power input electrically connected to the electrical panel, wherein the electrical panel is configured to direct electrical power from the first electrical power input to one or more circuits of the electrical panel; a power backup interface configured to receive power from a second electrical power input; and a power storage mechanism configured to receive power from the power backup interface and to store power in one or more power storage cells, wherein, in response to a determination that the electrical power from the first electrical power input at the electrical panel is less than a threshold, the control circuit, having been configured using at least one configuration characteristic, selectively controls a state of at least one circuit of the one or more circuits of the electrical panel and selectively directs power, received from the power storage mechanism and converted by the inverter, to the electrical panel.

Clause 13. The power management apparatus of claim 12, wherein the first electrical power input is associated with an electrical grid.

Clause 14. The power management apparatus of claim 12, wherein the second electrical power input is associated with at least one renewable energy source.

Clause 15. The power management apparatus of claim 14, wherein the at least one renewable energy source includes at least one of a solar energy source and a wind energy source.

Clause 16. The power management apparatus of claim 12, wherein the power storage mechanism includes a battery comprising the in one or more power storage cells.

Clause 17. The power management apparatus of claim 12, wherein the power storage mechanism includes a battery bank comprising a plurality of batteries, and wherein the one or more power storage cells are associated with at least some of the plurality of batteries.

Clause 18. A power management method comprising: receiving, at a user interface, at least one input; generating at least one configuration characteristic based on the at least one input; configuring a control circuit using the at least one configuration characteristic, wherein the control circuit is associated with an inverter; and, in response to a determination that electrical power from a first electrical power input at an electrical panel is less than a threshold, using the control circuit: selectively controlling a state of at least one circuit of the electrical panel; and selectively directing power, received from a power storage mechanism and converted by the inverter, to the electrical panel, wherein the power storage mechanism receives electrical power from a second electrical power input.

Clause 19. The power management method of claim 18, wherein the first electrical power input is associated with an electrical grid.

Clause 20. The power management method of claim 18, wherein the second electrical power input is associated with at least one renewable energy source.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

1. A power management system comprising:
an electrical panel including a plurality of circuits, each circuit being associated with an electrical load;
a first electrical power input electrically connected to the electrical panel, wherein the electrical panel is configured to direct electrical power from the first electrical power input to one or more of the circuits;
a power backup interface configured to receive power from a second electrical power input;
a power storage mechanism configured to receive power from the power backup interface and to store power in one or more power storage cells;
an inverter electrically connected to the power storage mechanism and the electrical panel;
a control circuit configured to selectively control a state of each circuit of the electrical panel based on at least one configuration characteristic; and
a computing device configured to:
receive at least one input;
generate at least one configuration characteristic based on the at least one input; and
configure the control circuit using the at least one configuration characteristic.

2. The power management system of claim 1, wherein the first electrical power input is associated with an electrical grid.

3. The power management system of claim 1, wherein the second electrical power input is associated with at least one renewable energy source.

4. The power management system of claim 3, wherein the at least one renewable energy source includes at least one of a solar energy source and a wind energy source.

5. The power management system of claim 1, wherein the power storage mechanism includes a battery comprising the in one or more power storage cells.

6. The power management system of claim 1, wherein the power storage mechanism includes a battery bank comprising a plurality of batteries, and wherein the one or more power storage cells are associated with at least some of the plurality of batteries.

7. The power management system of claim 1, wherein the control circuit, having been configured using the at least one configuration characteristic, determines whether the electrical power from the first electrical power input at the electrical panel is less than a threshold.

8. The power management system of claim 7, wherein, in response to a determination that the electrical power from the first electrical power input at the electrical panel is less than the threshold, the control circuit, having been configured using the at least one configuration characteristic, selectively change a state of at least one circuit of the electrical panel from a first state to a second state.

9. The power management system of claim 8, wherein the inverter converts power from the power storage mechanism and provides the converted power to the electrical panel.

10. The power management system of claim 7, wherein, in response to a determination that the electrical power from the first electrical power input at the electrical panel is less than the threshold, the control circuit, having been configured using the at least one configuration characteristic, receives an instruction, via the computing device, to change a state of at least one circuit of the electrical panel from a first state to a second state.

11. The power management system of claim 10, wherein the instruction corresponds to input provided by a user at the computing device.

12. A power management apparatus comprising:
a control circuit associated with an inverter, the control circuit being electrically connected to an electrical panel;
a first electrical power input electrically connected to the electrical panel, wherein the electrical panel is configured to direct electrical power from the first electrical power input to one or more circuits of the electrical panel;
a power backup interface configured to receive power from a second electrical power input; and
a power storage mechanism configured to receive power from the power backup interface and to store power in one or more power storage cells, wherein, in response to a determination that the electrical power from the first electrical power input at the electrical panel is less than a threshold, the control circuit, having been configured using at least one configuration characteristic, selectively controls a state of at least one circuit of the one or more circuits of the electrical panel and selectively directs power, received from the power storage mechanism and converted by the inverter, to the electrical panel.

13. The power management apparatus of claim 12, wherein the first electrical power input is associated with an electrical grid.

14. The power management apparatus of claim 12, wherein the second electrical power input is associated with at least one renewable energy source.

15. The power management apparatus of claim 14, wherein the at least one renewable energy source includes at least one of a solar energy source and a wind energy source.

16. The power management apparatus of claim 12, wherein the power storage mechanism includes a battery comprising the in one or more power storage cells.

17. The power management apparatus of claim 12, wherein the power storage mechanism includes a battery bank comprising a plurality of batteries, and wherein the one or more power storage cells are associated with at least some of the plurality of batteries.

18. A power management method comprising:
receiving, at a user interface, at least one input;
generating at least one configuration characteristic based on the at least one input;
configuring a control circuit using the at least one configuration characteristic, wherein the control circuit is associated with an inverter; and
in response to a determination that electrical power from a first electrical power input at an electrical panel is less than a threshold, using the control circuit:
selectively controlling a state of at least one circuit of the electrical panel; and
selectively directing power, received from a power storage mechanism and converted by the inverter, to the electrical panel, wherein the power storage mechanism receives electrical power from a second electrical power input.

19. The power management method of claim 18, wherein the first electrical power input is associated with an electrical grid.

20. The power management method of claim 18, wherein the second electrical power input is associated with at least one renewable energy source.
